(19) United States
(12) Patent Application Publication
(10) Pub. No.: US 2022/0067129 A1
(43) Pub. Date: Mar. 3, 2022

(54) ENCRYPTION TO LIMIT DIGITALLY ALTERED IMAGING DATA

(71) Applicant: DRAGONFRUIT AI, INC, Menlo Park, CA (US)

(72) Inventor: Amit Kumar, Menlo Park, CA (US)

(21) Appl. No.: 17/004,306

(22) Filed: Aug. 27, 2020

(51) Int. Cl. G06F 21/16; G06F 21/62; H04L 9/06; H04L 9/08; H04N 21/454

(52) U.S. Cl. CPC G06F 21/16; G06F 21/6209; H04N 21/4542; H04L 9/0822; H04L 9/0643

(57) ABSTRACT

Systems, methods, and software described herein manage the verification of video data from end user computing elements. In one implementation, a computing element obtains a frame of video data from a video source. Once received, the system applies at least one encryption key or hash to the frame to encode authentication information for the video data in the frame and communicates the frame with the encoded authentication information to a video processing system.

### BACKGROUND

Online video platforms provide users with the ability and view various genres of videos from multiple sources. These videos may provide news, education, entertainment, or some other service to the users of the video platform. However, with the advances in hardware and software capabilities on computing systems, videos may be edited and modified to provide a different narrative than intended from the original video creator. For example, a user may record a video and upload the video to a social media website. Once uploaded, one or more other users may edit the video and reupload the video to include different persons, video portions that were not included in the original video, or some other change the original video.

Additionally, while advances have been made in the ability to edit and modify videos, difficulties arise in determining when the videos have been modified. In particular, issues arise in managing copyright protection for original videos or ensuring that persons included in the videos are protected from improper portrayals.

### Overview

Provided herein are systems, methods, and software for using encryption to limit digitally altered imaging data. In one implementation, a system may include a source computing element and a video processing system. The source computing element may be configured to obtain a frame of video data from a video source, such as an image capture device. Once obtained, the computing element applies at least one encryption key or hash to the frame to encode authentication information for the video data in the frame and communicates the frame with the encoded authentication information to a video processing system.

The video processing system may receive the frame as part of the video data and determine the at least one encryption key or hash associated with the computing element. The video processing system may further apply the at least one encryption key or hash to the frame to determine whether the frame for the video data is authenticated.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a computing environment to manage digitally altered imaging data according to an implementation.

FIG. 2 illustrates an operation of a computing element to manage the encryption of imaging data according to an implementation.

FIG. 3 illustrates an operation of a video processing system to validate imaging data from a computing element according to an implementation.

FIG. 4 illustrates an operational scenario or communicating imaging data from a computing element to a video processing system according to an implementation.

FIG. 5 illustrates an operational scenario or communicating imaging data from a computing element to a video processing system according to an implementation.

FIG. 6 illustrates an operational scenario of encoding information in a frame according to an implementation.

FIG. 7 illustrates an operation of a computing element to encode information in a frame according to an implementation.

FIG. 8 illustrates an operation of a video processing system to identify errors in video data according to an implementation.

FIG. 9 illustrates a user computing system to send authenticated video data according to an implementation.

FIG. 10 illustrates a video processing computing system to authenticate video data according to an implementation.

### DETAILED DESCRIPTION

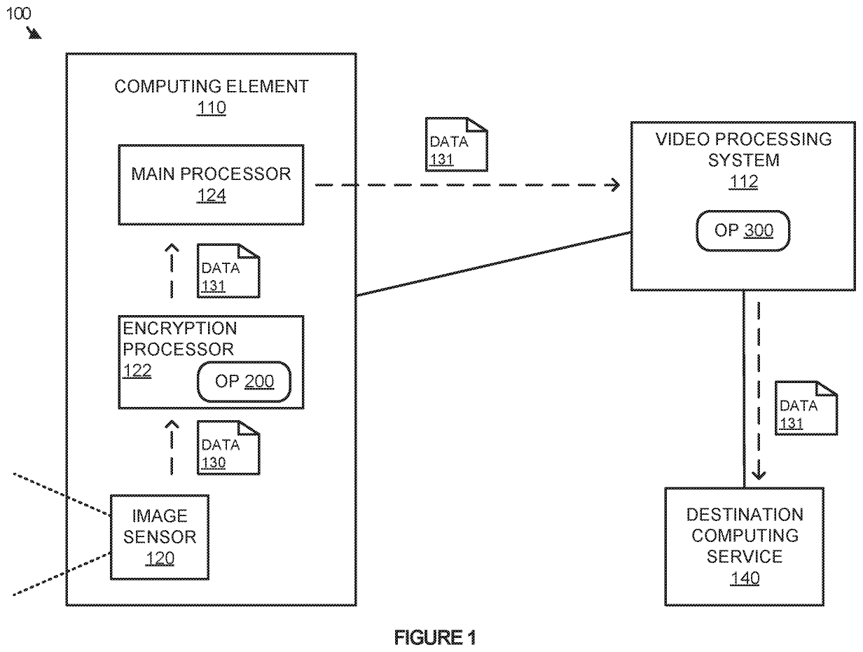

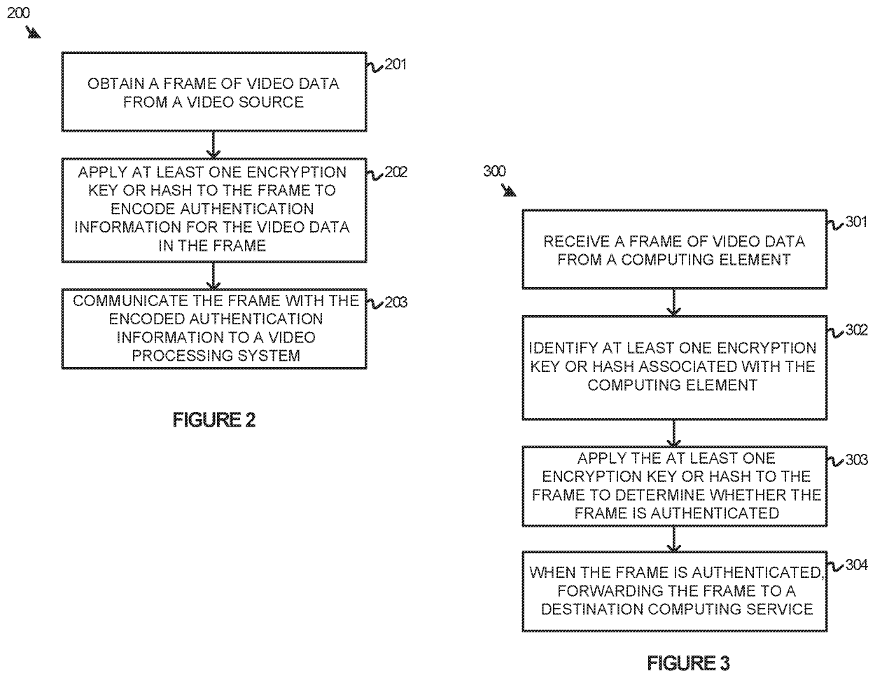

FIG. 1 illustrates a computing environment 100 to manage digitally altered imaging data according to an implementation. Computing environment 100 includes computing element 110, video processing system 112, video data 130-131, and destination computing service 140. Computing element 110 further includes image sensor 120, encryption processor 122, and main processor 124. Although demonstrated as separate, it should be understood that encryption processor 122 may be integrated wholly or partially on image sensor 120 or main processor 124. Encryption processor 122 is configured to provide operation 200 that is further described below with respect to FIG. 2 and video processing system 112 is further configured to provide operation 300 that is further described below with respect to FIG. 3.

In operation, image sensor 120 collects video data 130 and provides the video data as a plurality of frames to encryption processor 122. Encryption processor 122 may comprise one or more microprocessors, Field Programmable Gate Arrays (FPGAs), Application Specific Integrated Circuits (ASICs), and the like. Encryption processor 122 may be allocated one or more encryption keys or hashes that can be used to authenticate the video data as originating from image sensor 120. In some implementations, as part of joining a service provided by video processing system 112, different computing elements may be allocated unique hashes or encryption keys to verify video data as originating from the device. In the example of a hash, a hash may be applied to image data, such as groups of pixels, to determine a unique value associated with the group of pixels. In particular, the hash may take the values associated with a group of pixels and determine a fixed-sized value that corresponds to the group of pixels. The hashed value may then be added to the frame to generate video data 131 from video data 130. In another example, an encryption key may be used to encrypt authentication information associated with computing element 110 and may add the encrypted information to the frame. In a further example, a hash may be applied to identifier information for computing element and/or pixel data for the frame to determine a fixed-sized value. The fixed-sized value can then be added to the frame to provide authentication of the video data. In some implementations, the hashed or encrypted values may be appended or used to replace values in the pixels of the frame. In other implementations, the hashed or encrypted values may be appended to the end of the data for the frame.

Once the hashed or encrypted values are determined and integrated with the frame, computing element 110 may communicate video data 131 to video processing system 112 via main processor 124, which may include one or more microprocessors in some configurations. As video data 131 is received at video processing system 112, video processing system 112 may determine one or more encryption keys or hashes that are associated with the computing element. For example, computing element 110 may provide in the communication to video processing system 112 unique identifier information associated with the device or sensor, addressing information associated with the device, such as an internet protocol (IP) address, or some other information to identify the sensor or device. Based on the identifying information, video processing system 112 may select the one or more hashes or encryption keys that correspond to the computing element and may apply the identified hashes or encryption keys to the frames of the video data to determine whether the frame for the video data is valid. If authenticated, the video data may be forwarded to destination computing service 140, wherein destination computing service 140 may comprise a video sharing service, a storage server, another end computing element, or some other computing service. If the video data is not authenticated, the video data may be blocked, and a notification may be presented back to the computing element or an administrative console associated with video processing system 112. While demonstrated as separate from destination computing service 140, it should be understood that the authentication operations provided by video processing system 112 may be implemented by destination computing service 140.

Although demonstrated in the example of FIG. 1, using an image sensor to supply the video data to encryption processor 122, it should be understood that the video data may be obtained from a video editing application or other video generating application on computing element 110.

FIG. 2 illustrates an operation 200 of a computing element to manage the encryption of imaging data according to an implementation. The steps of operation 200 are referenced parenthetically in the paragraphs that follow with reference to systems and elements of computing environment 100 of FIG. 1.

As depicted, operation 200 includes (201) obtaining a frame of video data from a video source. The video source may comprise an imaging sensor or may include video editing software in some examples. Once obtained, operation 200 further includes (202) applying at least one encryption key or hash to the frame to encode authentication information for the video data in the frame. In some implementations, a computing element may include an encryption processor, such as encryption processor 122, that is dedicated hardware to process video data from a video source. This processing may occur prior to the video data being provided to a main or central processing system (CPU) for the computing element. Once the hashes or encryption keys are applied, the video data may be forwarded to main processor 124. In some implementations, in applying the hash or encryption key, encryption processor 122 may encode authentication information in the pixels of the image. For example, a hash may be applied to one or more pixels to determine a value and the value may be added or integrated into the data for another pixel. In another implementation, device information, such as a unique identifier, may be encoded into the data associated with a pixel. It should be understood that different combinations of one or more hashes and/or encryption keys can be used to encode and authenticate video data 130 from image sensor 120.

Once the authentication information is encoded, encryption processor 122 may communicate (203) the frame with the encoded authentication information to a video processing system. In some examples, encryption processor 122 may provide the video data to main processor 124, which in turn forwards the video data to video processing system 112. In some examples, main processor 124 may perform additional operations on the video data, such as editing, color correcting, or providing some other operation on the data. The authentication information may be used by video processing system 112 to authenticate the source of the video data.

In some implementations, in applying an encryption key to the frame, encryption processor 122 may identify image attributes within the frame, encrypt the image attributes, and add the encrypted image attributes to the frame. The image attributes may include objects identified in the frame, colors of objects identified in the frame, locations of objects in the frame, or some other information about the objects in the frame. The image attributes may be selected based on prevalence, based on uniqueness to identify the object, or based on some other factor. Once identified, an encryption key allocated to encryption processor 122 may encrypt the data and add the encrypted image attributes to the frame, wherein the attributes may be added as a replacement for one or more pixels, added to the end of the frame data, or added in some other manner to the frame prior to communicating the frame to a video processing system.

FIG. 3 illustrates an operation 300 of a video processing system to validate imaging data from a computing element according to an implementation. The steps of operation 300 are referenced parenthetically in the paragraphs that follow with reference to computing environment 100 of FIG. 1. Although demonstrated as separate from the destination computing service 140, it should be understood that the destination computing service may perform the authentication operations of video processing system 112.

As depicted, operation 300 includes receiving (301) a frame of video data from a computing element. In response to receiving the frame, video processing system 112 identifies (302) at least one encryption key or hash associated with the computing element. In some implementations, computing element 110 may provide identifier information to video processing system 112, wherein the identifier information may include an IP address, a MAC address, a unique identifier, or some other information to identify the computing element. Once identified, video processing system 112 applies (303) the at least one encryption key or hash to the frame to determine whether the frame is authenticated. When the frame is authenticated, video processing system 112 forwards (304) the frame to a destination computing service.

In one implementation, video processing system 112 may apply a hash to a portion of the video data or pixels in the frame to determine a first value. The first value may then be compared to a second value in the frame to determine whether the first value matches the second value. If the values match, then the frame is authenticated, and the frame may be forwarded to a destination computing service. In some examples, video processing system 112 may perform multiple hashes on the data for the frame, wherein each of the hashed values may be compared to other values included in the frame.

In another implementation, video processing system 112 may apply an encryption key to data in the frame to determine whether the data matches an expected value. For example, when computing element 110 captures the video data, encryption processor 122 may encrypt information, such as a unique identifier for the computing element in the frame. Video processing system 112 may identify the encrypted information in the frame and apply an encryption key to the encrypted information to determine whether the information matches an expected value. If a match is identified, then the frame may be authenticated, however, if a match is not identified, then the frame may be dropped or blocked. In some examples, if a single frame is dropped, then the rest of the video data may also be blocked. Moreover, while the previous examples used a single encryption key or hash, it should be understood that multiple keys or hashes may be applied to a frame. For example, different portions of a frame may include different values generated from one or more hash functions. Advantageously, different portions of the frame may be authenticated before the frame is forwarded to destination computing service 140.

Although demonstrated in the previous example using a single frame, it should be understood that video processing system 112 may implement similar operations on multiple frames received as part of video data 131. Video processing system 112 may process each individual frame to determine whether the frame is authenticated, may process frames at periodic intervals, or may process frames at some other intervals. In some implementations, video processing system 112 may dynamically alter the rate at which frames are tested for authentication. The changes in testing rate may be determined based on the amount of authenticated video provided from the computing element previously, based on the load at the video processing system, or based on some other factor. For example, when a computing element initially provides video data to video processing system 112, the video processing system may authenticate frames at a first rate. As the computing element becomes trusted based on the amount of authenticated video data, the video processing system may change the testing rate from the first rate to a second rate.

In some implementations, the video data received from the computing element may include image attributes that are encrypted into the frame. In particular, the video processing system may identify the encrypted attributes in the frame and apply a key associated with computing element 110 to decrypt the image attributes. If no attributes exist or the key cannot be applied, then video processing system 112 may determine that the frame is not authenticated. Additionally, if the attributes can be decrypted, the attributes may be compared to observations of the image by video processing system 112 to determine if the observations match the included attributes. If a match exists, or all the attributes are identified in the frame, then the frame is authenticated and can be forwarded to a destination service. Otherwise, if a match does not exist, video processing system 112 may determine that the frame is not authenticated. When the frame is not authenticated, video processing system 112 may prevent the frame, and in some examples the rest of the video data, from being forwarded to a destination computing service. Additionally, video processing system 112 may determine what might be missing from the frame and generate a notification for a user or administrator about the changes to the frame. In determining what is missing from the frame, video processing system 112 may process frames from the computing element with earlier or later timestamps and determine image attributes from the frames. The attributes may then be compared with the frame that was not authenticated to determine what, if anything, is missing in the current frame. For example, if a purple car were identified in one or more frames prior to the non-authenticated frame, video processing system 112 may using image recognition to determine if a purple car is present in the current frame. If it is not located, an indication may be provided to an administrator or tagged along with the video data to indicate possible changes in the video data.

In some examples, computing element 110 and video processing system 112 may encode and check each frame of video data. In other implementations, computing element 110 and/or video processing system 112 may check the frames at different intervals, wherein the intervals may be periodic, may be based on the history associated with computing element 112, or may be based on some other factor.

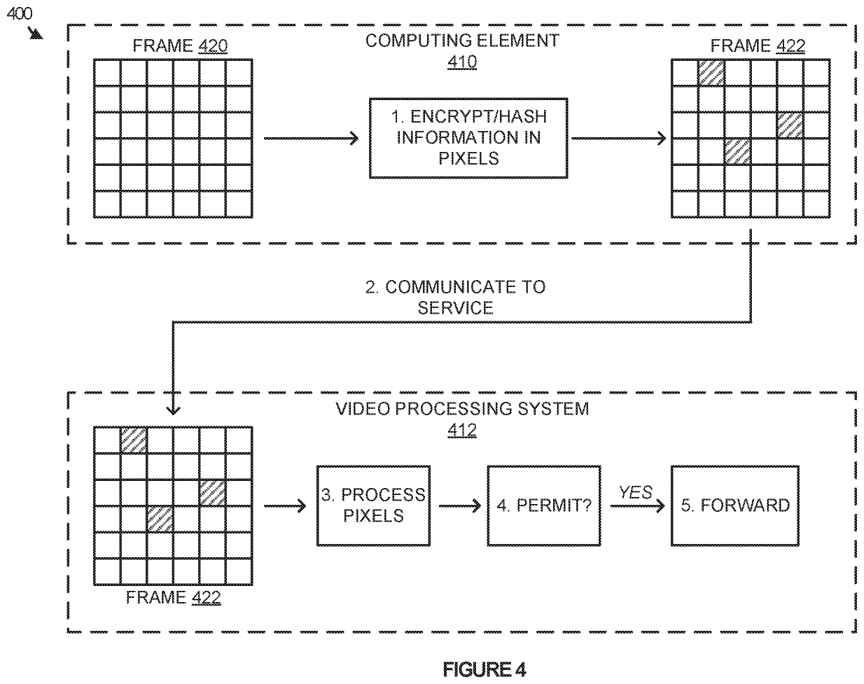

FIG. 4 illustrates an operational scenario 400 or communicating imaging data from a computing element to a video processing system according to an implementation. Operational scenario 400 includes computing element 410 and video processing system 412. Computing element 410 further includes frames 420 and 422, wherein frame 422 is forwarded to video processing system 412.

In operation, an image sensor on computing element 410 may capture video data as frames, wherein each of the frames comprises a plurality of pixels. As the video data is captured, a processing system on computing element 410 may encrypt or hash, at step 1, authentication information into the pixels of the original frame 420 to generate frame 422. In some examples, the processing system may comprise a separate processing system from the main processing system of the computing element. In particular, as image data is gathered from the image sensor, the image data may be passed through an authentication processor to generate frame 422. Once generated, frame 422 may be provided to the main processing system.

In some examples, computing element 410 may apply a hash to the frame to generate the authentication information. A hash may take data from the original image and generate a value of a defined length. This value may then be added or appended to data associated with one or more pixels in the frame, demonstrated in frame 422 as shaded pixels. For example, a hash may be applied to the pixel data associated with a first portion of the frame to return a value. The value may then be used to replace a pixel or add to the data of the frame to provide authentication associated with the frame. Advantageously, the type of hash used, the size of the hash value, and the pixels selected to be applied to the hash, or some other characteristic may be used to provide security in authorizing the video data from the image sensor.

Similar to the operations described above with respect to a hash, computing element 410 may encrypt information and incorporate the encrypted information in the frame. The encryption may be used to encrypt unique identifying information for the computing element or some other information that can be processed by video processing system 412. In some examples, a hardware processor associated with an imaging sensor may be encrypt unique identifying information associated with the sensor and/or the computing element. The information may be added or used to replace pixels in the frame. Although described in the previous examples as using encryption keys or hashes, it should be understood that some combination of hashes and/or encryption keys may be used to encode authentication information into the frame.

Once information is encoded into the frame to generate frame 422, frame 422 is communicated, at step 2, to video processing system 412. In response to receiving the frame, video processing system 412 may process, at step 3, the frame to determine whether the frame is valid. In some implementations, video processing system 412 may apply a hash or key to data identified in the frame and determine whether the result matches and expected value. For example, if computing element 410 encoded identifier information in the pixels for frame 422, video processing system 412 may identify a After the pixels are processed, video processing system 412 may determine whether the packet permitted, at step 4, and if permitted, forward the packet to a destination service, at step 5. For example, video processing system 412 may perform a hash on one or more pixels in the image and compare the generated value to a value included in the data for the pixel. If a match is identified, the frame may be verified and forwarded to the destination service.

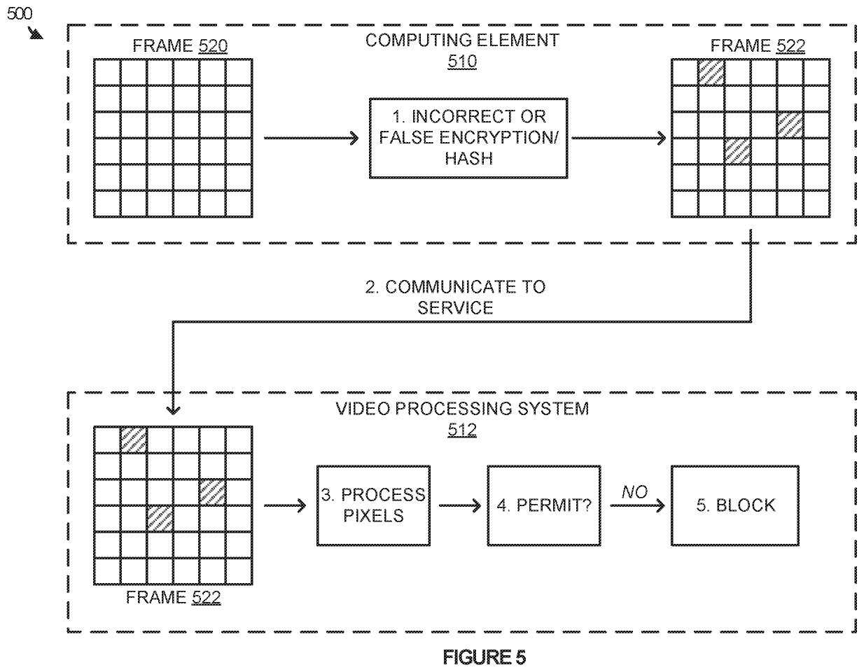

FIG. 5 illustrates an operational scenario 500 or communicating imaging data from a computing element to a video processing system according to an implementation. Operational scenario 500 includes computing element 510 and video processing system 512. Computing element 510 further includes frames 520 and 522, wherein frame 522 is forwarded to video processing system 512.

In operation, computing element 510 may obtain a packet and perform, at step 1, and incorrect or false hash or encryption to frame 520. The false or incorrect hash may include not implementing any hash or encryption to the frame, performing an improper hash or encryption, or some other operation not associated with computing element 510. For example, a video editing application may not perform any hash or encryption operations prior to sending a video to video processing system 512. Alternatively, in the example of operational scenario 500, an operation on computing element 510 may use a hash or encryption process that is not allocated to the computing system.

Once frame 522 is generated from the incorrect operations, the frame is communicated, at step 2, to video processing system 512. Video processing system 512 may process the pixels, at step 3, to identify authentication information in the packet and may determine whether the frame is permitted based on the authentication information, at step 4. In some implementations, video processing system 512 may identify authentication information based on the data, such as pixel data, included in the frame and compare the data to an expected result. For example, video processing system 512 may perform a hash on data from one or more pixels and compare the result to a hashed value included with the frame. If the information matches an expected result, then the frame may be permitted. However, as demonstrated in the example of FIG. 5, when the expected values do not match for a particular frame, then the frame may be rejected or blocked, at step 5, preventing the frame from reaching the destination service.

In some implementations, when a frame is blocked, the remaining frames of the video data may also be blocked. For example, a computing device uploading video data to a news site may be checked to determine whether any modifications were done to the video by the computing device or another video editing computing element. If a frame were indicated to be modified or included an improper signature with the frame, then the video may be prevented from being added to the news site. In some implementations, video processing system 512 may process frames at various intervals to authenticate or verify the video data from the computing element. For example, video processing system 512 may check every tenth frame of the video data to determine whether the video data is authenticated. In some instances, the check rate or authentication rate for determining whether the video data is authenticated from the computing element may be dynamic based on the identity of the communicating device, based on the type of video being transmitted, based on the preferences of the end service for the video data, or based on some other factor.

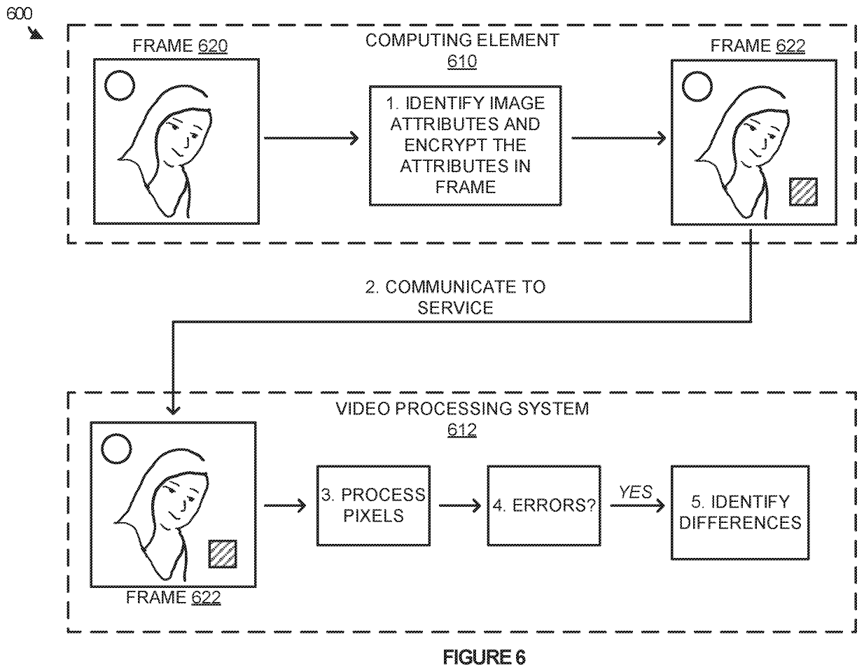

FIG. 6 illustrates an operational scenario 600 of encoding information in a frame according to an implementation. Operational scenario 600 includes computing element 610 and video processing system 612.

In operation, a computing element may obtain frame 620 of video data, wherein frame 620 may be obtained from an image sensor or an image generating application. When frame 620 is obtained, computing element 610 identifies image attributes, at step 1, and encrypts the attributes in the frame to generate frame 622. The image attributes may include objects identified in the image, colors of the objects in the image, the location of the objects in the image, the orientation of an object in an image, or some other information about the image. For example, if a frame of video data included a woman with brown eyes, the attributes may include the woman and/or the brown eyes. In some implementations, the objects selected for the attributes may be based on the size of the objects in the image, the uniqueness of the objects, or some other factor. In some instances, a limited number of attributes may be identified based on the available storage space for the attributes in the data for the frame. Once the attributes are identified, the attributes may be encrypted using a key at the computing element and the attributes may be added to the frame demonstrated as frame 622 (represented by the shaded pixel or pixels in the frame). In some examples, the encrypted attributes may be added as a replacement or amended pixel in for frame 622, however, it should be understood that the attributes may be added anywhere to the data for the frame.

Once frame 622 is generated from the encrypted attributes, computing element 610 communicates, at step 2, to video processing system 612. Once received, video processing system 612 may identify an encryption key to decrypt the attributes frame 622 and may process the pixels, at step 3. Once processed, video processing system 612 may determine whether there are errors for the frame based on the processed pixels, at step 4. In some implementations, video processing system 612 may decrypt the image attributes from the frame and determine whether the image attributes are present in the frame. If the image attributes are not identified in the frame, then video processing system 612 may determine that the frame is not authenticated and may perform additional processes to determine what is missing from the frame, at step 5. In some examples, video processing system 612 may compare image attributes from previous frames that were authenticated from computing element 610 to determine what image attributes are missing from the current frame. Returning to the example of a woman with brown hair, if the hair were no longer brown, video processing system 612 may flag the difference and may generate a notification or summary of the differences between the frames. Consequently, when errors are identified, video processing system 612 may block the video data from being provided to a destination computing service and may generate a notification or summary for an administrator indicating identified changes between authenticated frames and non-authenticated frames.

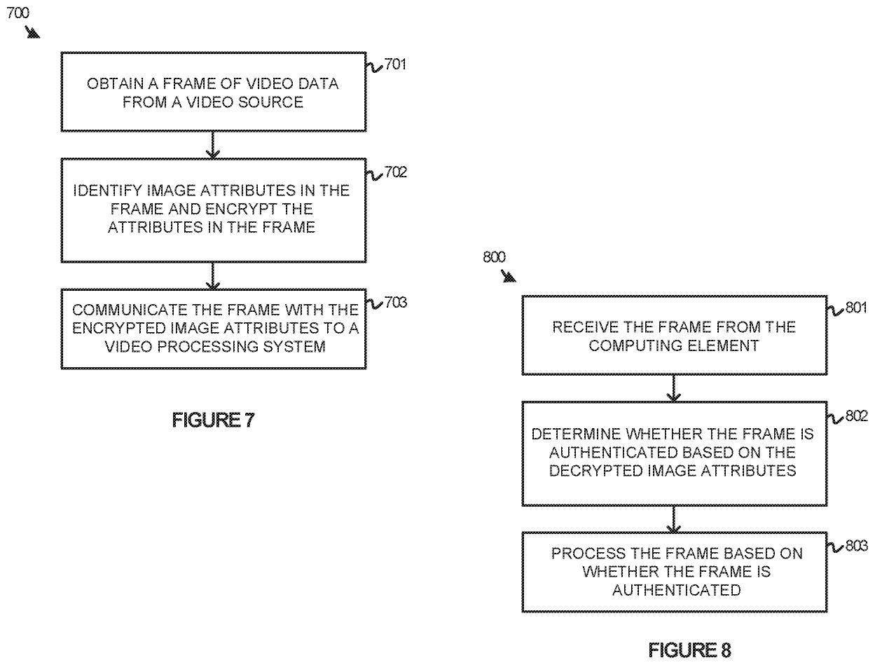

FIG. 7 illustrates an operation 700 of a computing element to encode information in a frame according to an implementation. The steps of operation 700 are referenced parenthetically in the paragraphs that follow and may be implemented by a computing element, such as computing element 610 of FIG. 6.

In operation, a computing element may obtain (701) a frame of video data from a video source, such as an image sensor on an end user computing device. Once obtained, the computing element may identify (702) one or more image attributes in the frame and encrypt the one or more image attributes in the frame. In some implementations, the image attributes may comprise object types identified in the frame, object colors identified in the frame, object locations within the frame, or some other information about the image captured for the frame. The attributes may be selected based on the prevalence in the frame, the uniqueness within the frame, or based on some other factor. For example, a birthmark of a person may be selected as an image attribute to uniquely identify the person within the frame. The information may then be added to the frame by replacing pixel data with the encrypted image attributes, appending the encrypted image attributes to a portion of the frame data, or adding the image attributes in some other manner.

In some examples, a computing element may be allocated an encryption key that can be used to encrypt the identified attributes. The identifying and encrypting of the attributes may be implemented on the main processing unit of the computing element or may be implemented by a dedicated processing unit capable of identifying and encrypting the attributes prior to providing the frame to the main processing unit. Once the attributes have been added to the frame, the frame may be communicated to a video processing system capable of authenticating the video data as originating from the computing element and/or an image sensor located on the computing element.

FIG. 8 illustrates an operation 800 of a video processing system to identify errors in video data according to an implementation. The steps of operation 800 are referenced parenthetically in the paragraphs that follow and may be implemented by a video processing system, such as video processing system 612 of FIG. 6.

In operation, a video processing system receives (801) a frame from a computing element and determines (802) whether the frame is authenticated based on image attributes decrypted from the frame. In some examples, the video processing system may identify an encryption key for the frame and apply the encryption key to a portion of data in the frame. The portion may include data for one or more pixels that have been replaced or changed to include image attribute data. Once the image attributes are identified, the video processing system may compare the decrypted image attributes to image attributes identified by the video processing system in the frame. If there is a match, then the frame may be classified as authenticated by the video processing system. However, if there is not a match, then the frame will not be authenticated by the video processing system.

Once it is determined whether the frame is authenticated, the video processing system may process (803) the frame based on whether the frame was authenticated. In some implementations, if the frame is authenticated, the frame is forwarded to a destination computing service, wherein the destination computing service may comprise a news service, a social media service, a video storage service, or some other service. If the frame is not authenticated, the video processing system may prevent or block the frame and other video data from the computing element from being forwarded to the destination computing service. Further, in some examples, the video processing system may determine what changed in the frame in relation to other frames that were received before or after the affected frame. In particular, the video processing system may compare decrypted image attributes identified in other frames and compare the attributes to the current frame to determine what is missing, added, or otherwise changed in the current frame. In some implementations, errors may be identified with a frame based on decrypted image attributes not being identified, however, errors may also be identified when the encrypted image attributes are not included with the frame. For example, a video editing application may remove the encrypted image attributes when editing the video data, preventing the video data from being authenticated.

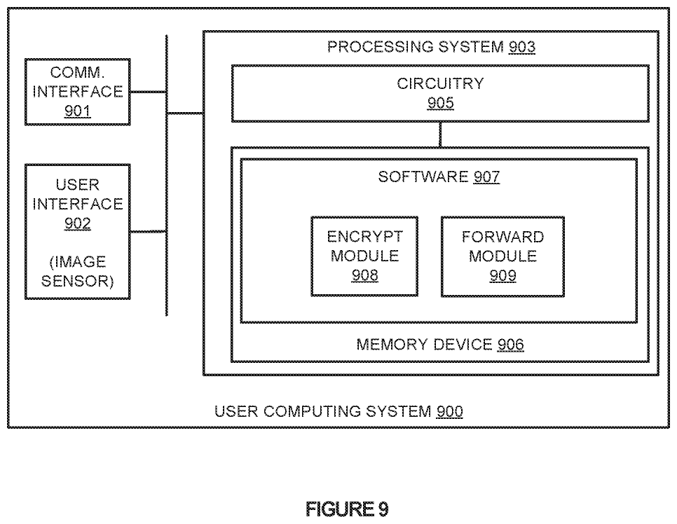

FIG. 9 illustrates a user computing system 900 to send authenticated video data according to an implementation. Computing system 900 is representative of any computing system or systems with which the various operational architectures, processes, scenarios, and sequences disclosed herein for an end computing element, such as computing element 110 of FIG. 1. Computing system 900 comprises communication interface 901, user interface 902, and processing system 903. Processing system 903 is linked to communication interface 901 and user interface 902. Processing system 903 includes processing circuitry 905 and memory device 906 that stores operating software 907. Computing system 900 may include other well-known components such as a battery and enclosure that are not shown for clarity.

Communication interface 901 comprises components that communicate over communication links, such as network cards, ports, radio frequency (RF), processing circuitry and software, or some other communication devices. Communication interface 901 may be configured to communicate over metallic, wireless, or optical links. Communication interface 901 may be configured to use Time Division Multiplex (TDM), Internet Protocol (IP), Ethernet, optical networking, wireless protocols, communication signaling, or some other communication format—including combinations thereof. In some implementations, communication interface 901 may be configured to communicate with a video processing system that can be used to verify or authenticate the video data from computing system 900.

User interface 902 comprises components that interact with a user to receive user inputs and to present media and/or information. User interface 902 may include a speaker, microphone, buttons, lights, display screen, touch screen, touch pad, scroll wheel, communication port, or some other user input/output apparatus—including combinations thereof. In some implementations, user interface 902 may include an image capture device to capture video data. User interface 902 may be omitted in some examples.

Processing circuitry 905 comprises microprocessor and other circuitry that retrieves and executes operating software 907 from memory device 906. Memory device 906 may include volatile and nonvolatile, removable and non-removable media implemented in any method or technology for storage of information, such as computer readable instructions, data structures, program modules, or other data. Memory device 906 may be implemented as a single storage device but may also be implemented across multiple storage devices or sub-systems. Memory device 906 may comprise additional elements, such as a controller to read operating software 907. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing circuitry 905 is typically mounted on a circuit board that may also hold memory device 906 and portions of communication interface 901 and user interface 902. Operating software 907 comprises computer programs, firmware, or some other form of machine-readable program instructions. Operating software 907 includes encrypt module 908 and forward module 909, although any number of software modules may provide the same operation. Operating software 907 may further include an operating system, utilities, drivers, network interfaces, applications, or some other type of software. When executed by processing circuitry 905, operating software 907 directs processing system 903 to operate computing system 900 as described herein.

In one implementation, encrypt module 908 directs processing system 903 to obtain a frame of video data from a video source. The video source may comprise an image capture device or sensor in user interface 902 or may comprise a video storage device on user computing system 900. When the frame is received, encrypt module 908 directs processing system 903 illustrates a user computing system to send authenticated video data according to an implementation to apply at least one encryption key or hash to the frame to encode authentication information for the video data in the frame. In some implementations, processing system 903 may separate the encryption processes from the main processing of the computing system. In particular, as video data is captured using the image sensor, the video may be processed by modules 908-909 prior to providing the data to the main processing system. Advantageously, the video data may be encoded with authentication information prior to any other operations, such as video editing, on the captured data. In some examples, the one or more encryption keys or hashes may be used to encode information into pixels or may be used to append information to the frame to authenticate the computing system. For example, encrypt module 908 may perform a hash on one or more pixels to generate a new value. The new value may then be added to the frame to authenticate the video data. Once the authentication information is encoded in the frame, forward module 909 directs processing system 903 to forward or communicate the frame with the encoded authentication information to a video processing system.

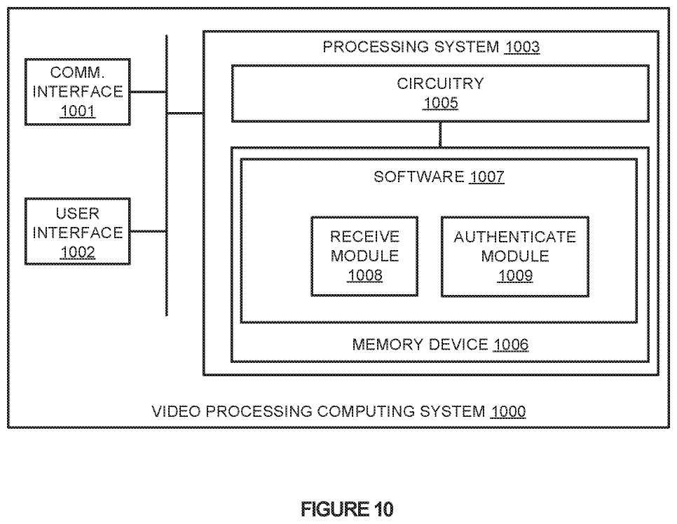

FIG. 10 illustrates a video processing computing system 1000 to authenticate video data according to an implementation Computing system 1000 is representative of any computing system or systems with which the various operational architectures, processes, scenarios, and sequences disclosed herein for an end computing element, such as computing element 110 of FIG. 1. Computing system 1000 comprises communication interface 1001, user interface 1002, and processing system 1003. Processing system 1003 is linked to communication interface 1001 and user interface 1002. Processing system 1003 includes processing circuitry 1005 and memory device 1006 that stores operating software 1007. Computing system 1000 may include other well-known components such as a battery and enclosure that are not shown for clarity.

Communication interface 1001 comprises components that communicate over communication links, such as network cards, ports, radio frequency (RF), processing circuitry and software, or some other communication devices. Communication interface 1001 may be configured to communicate over metallic, wireless, or optical links. Communication interface 1001 may be configured to use Time Division Multiplex (TDM), Internet Protocol (IP), Ethernet, optical networking, wireless protocols, communication signaling, or some other communication format—including combinations thereof. In some implementations, communication interface 1001 may be configured with one or more end computing elements, such as smartphones, desktop computers, digital cameras, or some other computing element.

User interface 1002 comprises components that interact with a user to receive user inputs and to present media and/or information. User interface 1002 may include a speaker, microphone, buttons, lights, display screen, touch screen, touch pad, scroll wheel, communication port, or some other user input/output apparatus—including combinations thereof. User interface 1002 may be omitted in some examples.

Processing circuitry 1005 comprises microprocessor and other circuitry that retrieves and executes operating software 1007 from memory device 1006. Memory device 1006 may include volatile and nonvolatile, removable and non-removable media implemented in any method or technology for storage of information, such as computer readable instructions, data structures, program modules, or other data. Memory device 1006 may be implemented as a single storage device but may also be implemented across multiple storage devices or sub-systems. Memory device 1006 may comprise additional elements, such as a controller to read operating software 1007. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing circuitry 1005 is typically mounted on a circuit board that may also hold memory device 1006 and portions of communication interface 1001 and user interface 1002. Operating software 1007 comprises computer programs, firmware, or some other form of machine-readable program instructions. Operating software 1007 includes receive module 1008 and authenticate module 1009, although any number of software modules may provide the same operation. Operating software 1007 may further include an operating system, utilities, drivers, network interfaces, applications, or some other type of software. When executed by processing circuitry 1005, operating software 1007 directs processing system 1003 to operate computing system 1000 as described herein.

In one implementation, receive module 1008 directs processing system 1003 to receive a frame of video data from a computing element and identify at least one encryption key or hash associated with the computing element. The encryption key or hash for the computing element may be determined based on an IP address associated with the computing element, a unique identifier for the computing element or image capture device, or some other identifier for the device. Once the at least one encryption key or hash is identified, authenticate module 1009 directs processing system 1003 to apply the at least one encryption key or hash to the frame to determine whether the frame is authenticated. As an example, a hash may be identified for a computing element based on an identifier associated with the computing element. The hash may then be applied to data in the frame to determine whether the frame is authenticated for the originating computing element. In applying the hash, authenticate module 1009 may select pixel data or other data from the frame and apply a hash to determine a value. If the value matches a hashed value included with the frame, then the frame is authenticated. Once authenticated, the frame may be forwarded to a destination computing service.

In some examples, computing system 1000 may authenticate each frame of a video using the one or more encryption keys or hashes associated with the computing element. In other implementations, frames may be tested at periodic intervals, at random, or at some other interval. The intervals may be based on the type of video data, the identity of the computing element, preferences of the destination computing service, or some other factor.

In some implementations, the communicating computing element may include a hardware or software module that encodes authentication information into the frame prior to permitting additional processing on the frame. For example, a smartphone may include processing hardware capable of encoding authentication information into the frame prior to permitting the computing element to modify or communicate the packet to the destination video processing computing system.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
in a computing element, obtaining a frame of video data from a video source;
applying at least one encryption key or hash to the frame to encode authentication information for the video data in the frame; and
communicating the frame with the encoded authentication information to a video processing system.

2. The method of claim 1, wherein the video source comprises an image capture device.

3. The method of claim 1, wherein the video source comprises video editing software.

4. The method of claim 1, wherein applying the at least one encryption key or hash to the frame comprises encoding the authentication information in data for one or more pixels of the image data.

5. The method of claim 1, wherein applying the at least one encryption key or hash to the frame to encode authentication information comprises applying the at least one hash to one or more groups of pixels.

6. The method of claim 1, wherein the at least one encryption key or hash is unique to the computing element in relation to one or more other computing elements associated with the video processing system.

7. The method of claim 1 further comprising communicating identifier information associated with the video source.

8. The method of claim 1, wherein applying the at least one encryption key or hash to the frame to encode authentication information comprises:
identifying one or more image attributes in the frame;
encrypting the one or more image attributes using the at least one encryption key; and
adding the encrypted image attributes to the frame.

9. The method of claim 1, wherein the one or more image attributes comprise one or more objects in the frame, one or more colors of objects in the frame, one or more locations of objects in the frame, or one or more orientations of objects in the frame.

10. A method comprising:
receiving a frame of video data from a computing element;
identifying at least one encryption key or hash associated with the computing element;
applying the at least one encryption key or hash to the frame to determine whether the frame is authenticated; and
when the frame is authenticated, forwarding the frame to a destination computing service.

11. The method of claim 10 further comprising, when the frame is not authenticated, blocking the frame.

12. The method of claim 10, wherein applying the at least one encryption key or hash to the frame to determine whether the frame is authenticated comprises:
identifying a first value in the frame;
applying a hash to one or more pixels in the frame to determine a second value;
determining whether the frame is authenticated based at least in part on whether the first value matches the second value.

13. The method of claim 10, wherein the at least one encryption key or hash is unique to the computing element in relation to one or more other computing elements.

14. The method of claim 10, wherein applying the at least one encryption key or hash to the frame to determine whether the frame is authenticated comprises:
applying the at least one encryption key to decrypt one or more image attributes in the frame;
determining whether the one or more image attributes are present in an image of the frame; and
determining that the frame is authenticated based on the one or more image attributes being present in the image of the frame.

15. The method of claim 14, wherein the one or more image attributes comprise one or more objects in the frame, one or more colors of objects in the frame, one or more locations of objects in the frame, or one or more orientations of objects in the frame

16. A system comprising:
a computing element configured to:
obtain a frame of video data from a video source;
apply at least one encryption key or hash to the frame to encode authentication information for the video data in the frame;
communicate the frame with the encoded authentication information to a video processing system; and
the video processing system configured to:
receive the frame from the computing element;
identify the at least one encryption key or hash associated with the computing element;
apply the at least one encryption key or hash to the frame to determine whether the frame is authenticated; and
when the frame is authenticated, forward the frame to a destination computing service.

17. The system of claim 16, wherein applying the at least one encryption key or hash to the frame to encode authentication information comprises:
identifying one or more image attributes in the frame;
encrypting the one or more image attributes using the at least one encryption key; and
adding the encrypted image attributes to the frame.

18. The system of claim 17, wherein applying the at least one encryption key or hash to the frame to determine whether the frame is authenticated comprises:
applying the at least one encryption key to decrypt one or more image attributes in the frame;
determining whether the one or more image attributes are present in an image of the frame; and
determining that the frame is authenticated based on the one or more image attributes being present in the image of the frame.

19. The system of claim 16, wherein applying the at least one encryption key or hash to the frame comprises encoding the authentication information in data for one or more pixels of the image data.

20. The system of claim 16, wherein the at least one encryption key or hash is unique to the computing element in relation to one or more other computing elements associated with the video processing system.
